(19) United States
(12) Patent Application Publication
(10) Pub. No.: US 2007/0070092 A1
(43) Pub. Date: Mar. 29, 2007

(54) Viewing angle adaptive brightness-correction method and image forming apparatus using the same

(75) Inventors: Hyun-soo Oh, Suwon-si (KR); Kyeong-man Kim, Yongin-si (KR); Mi-jung Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/525,875

(22) Filed: Sep. 25, 2006

(30) Foreign Application Priority Data
Sep. 28, 2005 (KR) 10-2005-0090712

(51) Int. Cl. G09G 5/10

(52) U.S. Cl. 345/690

(57) ABSTRACT

A viewing angle adaptive brightness-correction method is provided, in which brightness of an image is adaptively corrected according to a viewing angle and the brightness-corrected image is displayed by an image display unit whose orientation angle is controllable, and an image forming apparatus using the same. The viewing angle adaptive brightness-correction displaying method includes detecting the orientation angle of the image display unit, brightness-correcting an input image according to the detected orientation angle, and displaying the brightness-corrected image on the image display unit. Accordingly, in an image display unit, such as an LCD having an angle adjustment function attached to a digital camera, a photo-printer and so on, a displayed image can be corrected according to the orientation angle of the LCD or a viewing angle to show the same image to a user for various viewing angles.

### CROSS-REFERENCE TO RELATED PATENT APPLICATION

This application claims the benefit under 35 U.S.C. §119(a) of Korean Patent Application No. 10-2005-0090712, filed in the Korean Intellectual Property Office on Sep. 28, 2005, the entire disclosure of which is incorporated herein by reference.

### BACKGROUND OF THE INVENTION

1. Field of the Invention

The present invention relates to a viewing angle adaptive brightness-correction method and an image forming apparatus using the same. More particularly, the present invention relates to a viewing angle adaptive brightness-correction method in which an image displayed on an image display unit, such as an LCD having an angle adjustment function attached to a digital camera or a photo-printer, is corrected according to the orientation angle of the LCD or a viewing angle to display the same image to a user for various viewing angles, and an image forming apparatus using the same.

2. Description of the Related Art

With the rapid development of digital signal processing technologies and display devices, liquid crystal displays (LCDs) have become widely used in not only cellular phones and digital cameras, but also photo-printers. Although LCDs have smaller sizes and power consumption than cathode ray tubes (CRTs), LCDs are disadvantageous in that they have narrow viewing angles.

FIG. 1 is a perspective view of a photo-printer including an LCD panel having an angle adjustment function. Even when the field of vision of a user is fixed, an image shown to the user can be varied by adjusting the angle of the LCD panel. This is because a display device such as an LCD, displays an image whose brightness and color are varied according to a viewing angle. Accordingly, to correctly see an image displayed on the LCD having an angle adjustment function from various viewing angles, the angle of the LCD should be controlled such that a desired image can be displayed according to the field of vision of a user.

Accordingly, a need exists for a system and method for providing an image on an image display unit that is corrected according to orientation angle or viewing angle to display the same image to a user.

### SUMMARY OF THE INVENTION

Embodiments of the present invention substantially solve the above and other problems, and provide a viewing angle adaptive brightness-correction method in which an image displayed on an image display unit, such as an LCD having an angle adjustment function attached to a digital camera or a photo-printer, is corrected according to the orientation angle of the LCD or a viewing angle to display the same image to a user for various viewing angles, and an image forming apparatus using the same.

According to an aspect of embodiments of the present invention, a viewing angle adaptive brightness-correction method is provided comprising detecting the orientation angle of the image display unit, brightness-correcting an input image according to the detected orientation angle, and displaying the brightness-corrected image on the image display unit.

The step of brightness-correcting an input image comprises controlling a gamma parameter and brightness offset according to the detected orientation angle.

The step of brightness-correcting an input image comprises obtaining a gamma parameter and brightness offset corresponding to the detected orientation angle from a first look-up table in which angles, gamma parameters and brightness offset values are previously mapped. In the first look-up table, the angles, gamma parameters and brightness offset values are mapped based on brightness patterns of test images displayed for respective orientation angles.

The gamma parameters and brightness offset values are preferably mapped in the first look-up table for representative orientation angles, and the step of brightness-correcting an input image further comprises interpolating the gamma parameter and a brightness offset value from a neighboring representative orientation angle when the detected orientation angle does not correspond to one of the representative orientation angles stored in the first look-up table.

The step of brightness-correcting an input image comprises color-correcting the input image, and brightness-correcting the color-corrected image according to the detected orientation angle.

The step of color-correcting the input image comprises obtaining corrected color component values corresponding to color component values of pixels constituting the input image from a second look-up table in which the color component values and corrected color component values respectively corresponding to the color component values are previously mapped, and changing the color component values of the pixels to the obtained corrected color component values.

Corrected color component values for respective representative color component values are mapped in the second look-up table, and the step of color-correcting the input image comprises interpolating corrected color component values from neighboring color component values when the color component values of the pixels constituting the input image do not exist in the second look-up table, and changing the color component values of the pixels to the interpolated corrected color component values.

According to another aspect of embodiments of the present invention, an image forming apparatus is provided comprising an image display unit whose orientation angle is controllable, an angle detector for detecting the orientation angle of the image display unit, and an image correction unit for brightness-correcting an input image according to the detected orientation angle. The image display unit displays the brightness-corrected image.

The image correction unit obtains a gamma parameter and brightness offset corresponding to the detected orientation angle from a first look-up table in which angles, gamma parameters and brightness offset values are previously mapped.

In the first look-up table, the angles, gamma parameters and brightness offset values are mapped based on brightness patterns of test images displayed for respective orientation angles.

The gamma parameters and brightness offset values are mapped in the first look-up table for representative orientation angles. The image correction unit interpolates the gamma parameter and a brightness offset value from a neighboring representative orientation angle when the detected orientation angle does not correspond to one of the representative orientation angles stored in the first look-up table.

The image correction unit comprises a color correction unit for color-correcting the input image, and a brightness correction unit for brightness-correcting the color-corrected image according to the detected orientation angle.

The color correction unit obtains corrected color component values corresponding to color component values of pixels constituting the input image from a second look-up table in which the color component values and corrected color component values respectively corresponding to the color component values are previously mapped, and changes the color component values of the pixels to the obtained corrected color component values.

Corrected color component values for respective representative color component values are mapped in the second look-up table. The color correction unit interpolates corrected color component values from neighboring color component values when the color component values of the pixels constituting the input image do not exist in the second look-up table, and changes the color component values of the pixels to the interpolated corrected color component values.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other features and advantages of embodiments of the present invention will become more apparent by describing in detail exemplary embodiments thereof with reference to the attached drawings in which:

FIG. 1 is a perspective view of a photo-printer including an LCD panel having an angle adjustment function;

FIG. 2 is a diagram for explaining the viewing angle of a user with respect to the LCD panel of the photo-printer of FIG. 1;

FIG. 3 is a block diagram of an image forming apparatus having a viewing angle adaptive brightness-correction function according to an exemplary embodiment of the present invention;

FIGS. 4A, 4B, 4C and 4D are compensation function graphs for explaining an exemplary compensation function used in the image correction unit of FIG. 3;

FIGS. 5A and 5B show test images for obtaining the compensation function graphs of FIGS. 4A, 4B, 4C and 4D;

FIG. 6 is a block diagram of an exemplary image correction unit of FIG. 3;

FIG. 7 illustrates an exemplary second look-up table used in a color correction unit of FIG. 6;

FIG. 8 is a flow chart showing a viewing angle adaptive brightness-correction method according to an exemplary embodiment of the present invention; and

FIG. 9 is a flow chart showing operation 810 of FIG. 8 in detail.

Throughout the drawings, like reference numerals will be understood to refer to like parts, components and structures.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

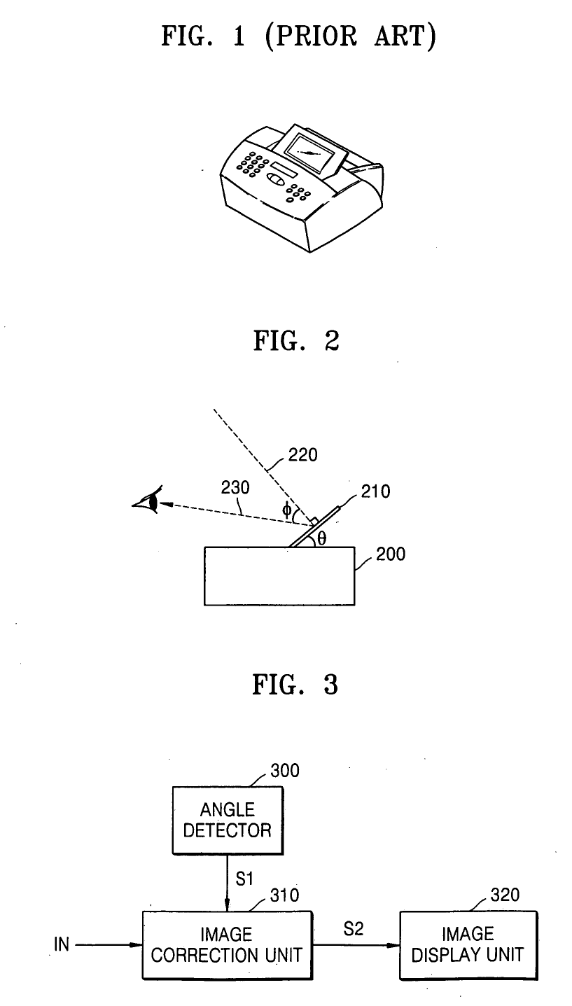

FIG. 2 is a diagram for explaining the viewing angle of a user with respect to the LCD panel of the photo-printer of FIG. 1. Referring to FIG. 2, an image display unit 210 such as an LCD panel having an angle adjustment function, is attached to an image forming apparatus 200 such as the photo-printer of FIG. 1. Even when the field of vision of the user is fixed, as shown in FIG. 2, the viewing angle φ can be varied by varying the orientation angle θ of the image display unit 210. Here, the viewing angle φ is defined as the angle between the normal 220 of the surface of the image display unit 210 and a line 230 connecting the center of the surface of the image display unit 210 and the eye of the user.

FIG. 3 is a block diagram of an image forming apparatus having a viewing angle adaptive brightness-correction function according to an exemplary embodiment of the present invention. The image forming apparatus comprises an angle detector 300, an image correction unit 310 and an image display unit 320.

The angle detector 300 detects the orientation angle θ of the image display unit 320. The position where the field of vision of a user is frequently placed is set, and image correction reflecting a viewing angle can be performed from the detected orientation angle θ. Embodiments of the present invention are described herein under the exemplary condition that the field of vision of the user is located on the normal 220 of the image display unit 210 when the orientation angle θ is 45°, and a first look-up table, described in greater detail below, is obtained under this exemplary condition. The orientation angle θ of the image display unit 320 can be obtained by receiving angle information from the image display unit 320 or detected using an angle sensing unit included in the angle detector 300.

The image correction unit 310 receives the angle information S1 detected by the angle detector 300, brightness-corrects an input image IN according to the detected viewing angle, and provides the brightness-corrected image S2 to the image display unit 320.

The input image IN is brightness-corrected by correcting a gamma parameter and a brightness offset according to the detected orientation angle θ. The brightness correction can be performed using a look-up table. That is, the image correction unit 310 obtains a gamma parameter and brightness offset corresponding to the detected orientation angle θ from a first look-up table in which orientation angles θ, gamma parameters and brightness offsets are previously mapped.

The orientation angle θ of the image display unit 320 is controllable as described above. The image display unit 320 displays the brightness-corrected image S2 to the user.

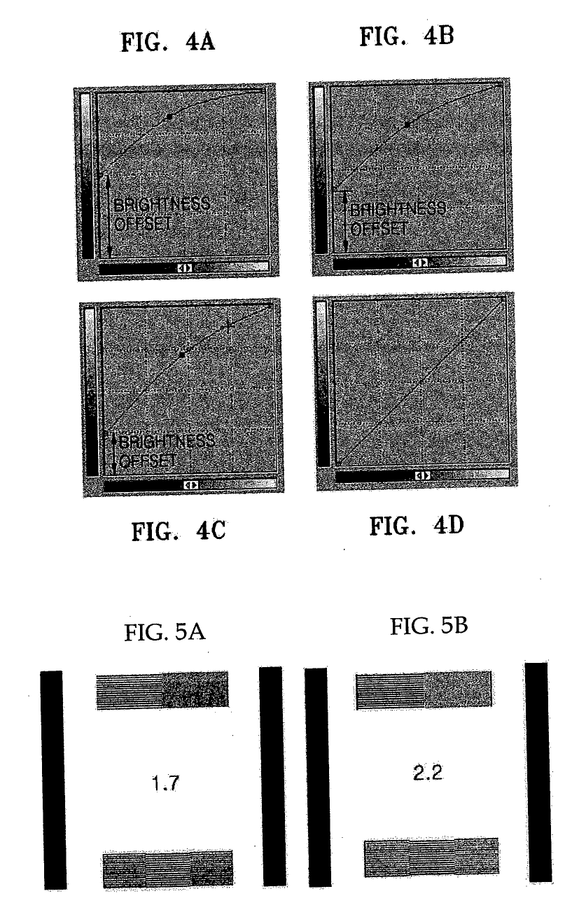

FIGS. 4A, 4B, 4C and 4D are compensation function graphs for explaining a compensation function used in the image correction unit 310 of FIG. 3. FIGS. 4A, 4B, 4C and 4D show compensation function curves when the orientation angle θ is 0°, 15°, 30° and 45°, respectively. Particularly, the compensation function curves are obtained when the field of vision of the user is located on the normal 220 of the image display unit 320 when the orientation angle θ is 45°.

In FIGS. 4A, 4B, 4C and 4D, the X-axes represent brightness values that pixels of the input image IN can have and the Y-axes represent corrected brightness values corresponding to the values of the brightness-corrected image S2 output from the image correction unit 310.

Each of the compensation function curves has a DC component corresponding to a brightness offset, and the curvature of each curve is determined by a gamma parameter. Under the aforementioned conditions of the position of the field of vision, the viewing angle φ is increased as the orientation angle θ becomes closer to 0°, and thus an image displayed without being corrected becomes darker. Accordingly, a larger brightness offset value is required for brightness correction as the orientation angle θ becomes closer to 0°.

The gamma parameters and brightness offset values used in the compensation functions are obtained by viewing brightness patterns of test images displayed under respective viewing angle conditions.

FIGS. 5A and 5B show test images for obtaining the compensation function graphs of FIGS. 4A, 4B, 4C and 4D. FIG. 5A shows a test image displayed when the gamma parameter is 1.7, and FIG. 5B shows a test image displayed when the gamma parameter is 2.2. The gamma parameter determines whether stripes included in a test image are recognized, and determines the brightness of the test image.

Under the aforementioned conditions of the field of vision, a gamma parameter corresponding to the test image displayed most distinctly is selected while varying the gamma parameter from 1.7 to 2.2 for each orientation angle θ. Specifically, the selected gamma parameter is applied to change the test images for each orientation angle θ, brightness offset values are respectively added to the data values of the changed test images, and the resultant images are displayed. A brightness offset value corresponding to the most distinct image among the displayed images is selected from the brightness offset values. The compensation function graphs of FIGS. 4A, 4B, 4C and 4D can then be obtained from the gamma parameters and the brightness offset values selected through the aforementioned process.

To apply the compensation function, the image correction unit 310 includes the first look-up table in which angles, gamma parameters and brightness offset values are mapped to obtain a gamma parameter and a brightness offset value corresponding to the detected orientation angle θ from the first look-up table. The compensation function curves of FIGS. 4A, 4B, 4C and 4D are obtained from the obtained gamma parameter and brightness offset, and brightness of the input image IN is corrected using the obtained compensation function curves. Furthermore, the first look-up table can store gamma parameters and brightness offset values for representative orientation angles instead of storing gamma parameters and brightness offset values for all possible orientation angles θ in order to reduce required storage capacity. That is, the first look-up table may store only gamma parameters and brightness offset values for the angles 0°, 15°, 30°and 45°, for example, as shown in FIGS. 4A, 4B, 4C and 4D. In this case, the image correction unit 310 can interpolate the gamma parameter and brightness offset value of the representative orientation angle closest to the detected orientation angle θ when the detected orientation angle θ does not correspond to any of the representative orientation angles stored in the first look-up table.

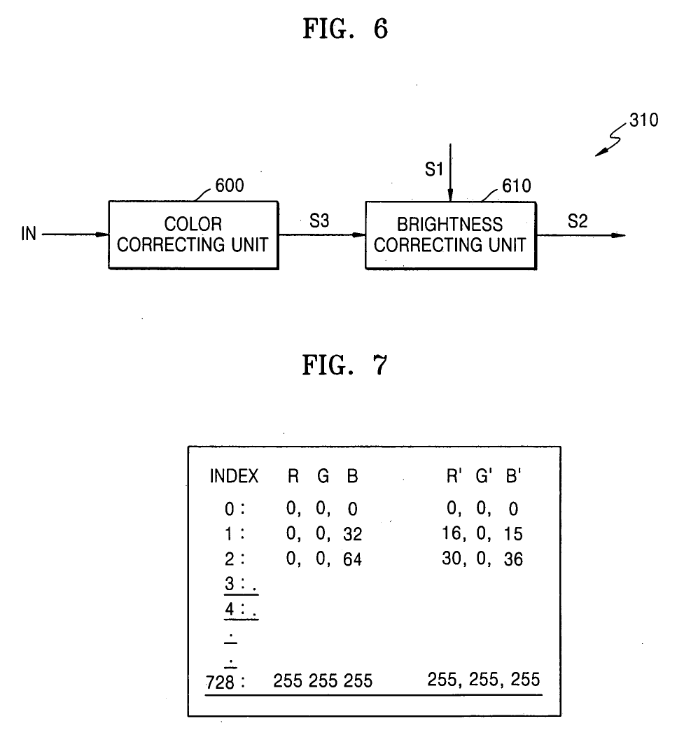

FIG. 6 is a block diagram of the image correction unit 310 of FIG. 3. The image correction unit 310 comprises a color correcting unit 600 and a brightness correcting unit 610.

The color correcting unit 600 corrects the color of the input image IN and provides color-corrected image data S3 to the brightness correcting unit 610. Color correction is the correction of a color component of an input image when the input image cannot be correctly displayed because of characteristics of the image display unit 320. In an embodiment of the present invention, the color correcting unit 600 obtains corrected color component values corresponding to color component values of pixels constituting the input image IN from a second look-up table in which color component values and corrected color component values respectively corresponding to the color component values are mapped, and then changes the color component values of the pixels to the obtained corrected color component values.

To minimize the required storage for the second look-up table, the second look-up table can store only corrected color component values for representative color component values. Then, the color correcting unit 600 interpolates corrected color component values corresponding to closest color component values when the color component values of the pixels of the input image IN do not exist in the second look-up table.

The brightness correcting unit 610 brightness-corrects the color-corrected image data S3 as described above.

FIG. 7 illustrates an exemplary second look-up table used in the color correcting unit 600 of FIG. 6. The second look-up table comprises representative values of R, G and B color components and R′, G′ and B′ corrected color component values respectively mapped to the representative values. The second look-up table shown In FIG. 7 does not include all R, G and B color component values but instead includes representative R, G and B color component values up to 255 with increments of 32 therebetween. For example, when the R, G and B color component values of the pixels constituting the input image IN are respectively 0, 0 and 32, the R′, G′ and B′ corrected color component values obtained from the second look-up table are respectively 16, 0 and 15. That is, when the R, G and B color component values of a pixel of the input image IN are respectively 0, 0 and 32, the color correcting unit 600 outputs 16, 0 and 15 as the R′, G′ and B′ corrected color component values for the pixel. Color components values that are not included in the second look-up table are interpolated from neighboring representative color component values.

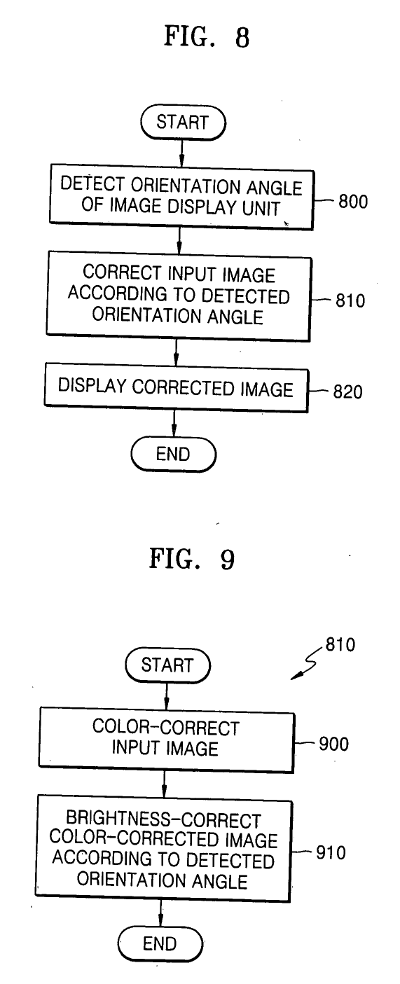

FIG. 8 is a flow chart showing a viewing angle adaptive brightness-correction method according to an exemplary embodiment of the present invention. Referring to FIG. 8, the orientation angle of the image display unit 320 is detected by the angle detector 300 in operation 800. The orientation angle is detected as described above.

The image correction unit 310 brightness-corrects the input image IN according to the detected orientation angle in operation 810. The brightness correction is carried out by controlling a gamma parameter and a brightness offset according to the detected orientation angle. Particularly, the input image IN is brightness-corrected using the gamma parameter and brightness offset corresponding to the detected orientation, which are obtained from the first look-up table in which angles, gamma parameters and brightness offset values are previously mapped. The first look-up table is obtained by mapping the angles, gamma parameters and brightness offset values based on brightness patterns of test images displayed for respective orientation angles. To reduce the storage required for the first look-up table, gamma parameters and brightness offset values for representative orientation angles can be stored in the first look-up table. In this case, when the detected angle does not correspond to any of the representative orientation angles stored in the first look-up table, the gamma parameter and brightness offset corresponding to the detected orientation angle are interpolated from a gamma parameter and a brightness offset value corresponding to a neighboring representative orientation angle.

The brightness-corrected image is displayed by the image display unit 320 to be shown to a user in operation 820.

FIG. 9 is a flow chart showing operation 810 of FIG. 8 in detail. First, the input image IN is color-corrected by the color correcting unit 600 in operation 900. Specifically, corrected color component values corresponding to color component values of pixels constituting the input image IN are obtained from the second look-up table in which respective color component values and corrected color component values corresponding thereto are previously mapped, and then the color component values of the pixels are changed to the obtained corrected color component values.

To reduce the storage required for the second look-up table, the second look-up table can store only corrected color component values for representative color component values. Then, the color correcting unit 600 interpolates corrected color component values corresponding to neighboring color components when the color component values of the pixels of the input image IN do not exist in the second look-up table.

The color-corrected image S3 is brightness-corrected by the brightness correcting unit 610 according to the detected orientation angle, as described above, in operation 910.

Embodiments of the present invention can also be embodied as computer-readable code on a computer-readable recording medium. The computer-readable recording medium can comprise any data storage device that can store data which can thereafter be read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network coupled computer systems so that the computer-readable code can be stored and executed in a distributed fashion. Also, functional programs, codes, and code segments for accomplishing embodiments of the present invention can be easily construed by programmers skilled in the art to which the present invention pertains.

According to embodiments of the present invention, in an image display unit, such as an LCD having an angle adjustment function attached to a digital camera, a photo-printer and so on, a displayed image can be corrected according to the angle of the LCD or a viewing angle to show the same image to a user for various viewing angles.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A viewing angle adaptive brightness-correction method in which brightness of an image is adaptively corrected according to a viewing angle and the brightness-corrected image is displayed by an image display unit whose orientation angle is controllable, the method comprising:
detecting the orientation angle of the image display unit;
brightness-correcting an input image according to the detected orientation angle; and
displaying the brightness-corrected image on the image display unit.

2. The method of claim 1, wherein the step of brightness-correcting an input image comprises controlling at least one of a gamma parameter and brightness offset according to the detected orientation angle.

3. The method of claim 2, wherein the step of brightness-correcting an input image comprises obtaining at least one of a gamma parameter and brightness offset corresponding to the detected orientation angle from a first look-up table in which at least one of angles, gamma parameters and brightness offset values are previously mapped.

4. The method of claim 3, wherein, in the first look-up table, the angles, gamma parameters and brightness offset values are mapped based on brightness patterns of test images displayed for respective orientation angles.

5. The method of claim 3, wherein:
the gamma parameters and brightness offset values are mapped in the first look-up table for representative orientation angles, and
the step of brightness-correcting an input image further comprises interpolating the gamma parameter and a brightness offset value from a neighboring representative orientation angle when the detected orientation angle does not correspond to one of the representative orientation angles stored in the first look-up table.

6. The method of claim 1, wherein the step of brightness-correcting an input image comprises:
color-correcting the input image; and
brightness-correcting the color-corrected image according to the detected orientation angle.

7. The method of claim 6, wherein the step of color-correcting the input image comprises:
obtaining corrected color component values corresponding to color component values of pixels constituting the input image from a second look-up table in which the color component values and corrected color component values respectively corresponding to the color component values are previously mapped; and
changing the color component values of the pixels to the obtained corrected color component values.

8. The method of claim 7, wherein the corrected color component values for respective representative color component values are mapped in the second look-up table, and the step of color-correcting the input image comprises:
interpolating corrected color component values from neighboring color component values when the color component values of the pixels constituting the input image do not exist in the second look-up table; and
changing the color component values of the pixels to the interpolated corrected color component values.

9. An image forming apparatus, comprising:
an image display unit having an orientation angle;
an angle detector for detecting the orientation angle of the image display unit; and
an image correction unit for brightness-correcting an input image according to the detected orientation angle,
wherein the image display unit is configured to display the brightness-corrected image.

10. The image forming apparatus of claim 9, wherein the image correction unit is configured to obtain at least one of a gamma parameter and brightness offset corresponding to the detected orientation angle from a first look-up table in which at least one of angles, gamma parameters and brightness offset values are previously mapped.

11. The image forming apparatus of claim 10, wherein, in the first look-up table, the angles, gamma parameters and brightness offset values are mapped based on brightness patterns of test images displayed for respective orientation angles.

12. The image forming apparatus of claim 10, wherein:
the gamma parameters and brightness offset values are mapped in the first look-up table for representative orientation angles, and
the image correction unit is configured to interpolate the gamma parameter and a brightness offset value from a neighboring representative orientation angle when the detected orientation angle does not correspond to one of the representative orientation angles stored in the first look-up table.

13. The image forming apparatus of claim 9, wherein the image correction unit comprises:
a color correction unit for color-correcting the input image; and
a brightness correction unit for brightness-correcting the color-corrected image according to the detected orientation angle.

14. The image forming apparatus of claim 13, wherein:
the color correction unit is configured to obtain corrected color component values corresponding to color component values of pixels constituting the input image from a second look-up table in which the color component values and corrected color component values respectively corresponding to the color component values are previously mapped, and change the color component values of the pixels to the obtained corrected color component values.

15. The image forming apparatus of claim 14, wherein:
corrected color component values for respective representative color component values are mapped in the second look-up table, and
the color correction unit is configured to interpolate corrected color component values from neighboring color component values when the color component values of the pixels constituting the input image do not exist in the second look-up table, and change the color component values of the pixels to the interpolated corrected color component values.

16. A computer-readable recording medium having stored thereon instructions for providing adaptive brightness-correction in which brightness of an image is adaptively corrected according to a viewing angle and the brightness-corrected image is displayed, comprising:
a first set of instructions for controlling a an angle detector to detect an orientation angle of an image display unit;
a second set of instructions for controlling an image correction unit to brightness-correct an input image according to the detected orientation angle; and
a third set of instructions for controlling an image display unit to display the brightness-corrected image.

17. The computer-readable recording medium of claim 16, wherein the second set of instructions further control at least one of a gamma parameter and brightness offset according to the detected orientation angle.

18. The computer-readable recording medium of claim 17, wherein the second set of instructions further obtain at least one of a gamma parameter and brightness offset corresponding to the detected orientation angle from a first look-up table in which at least one of angles, gamma parameters and brightness offset values are previously mapped.

19. The computer-readable recording medium of claim 18, wherein, in the first look-up table, the angles, gamma parameters and brightness offset values are mapped based on brightness patterns of test images displayed for respective orientation angles.

20. The computer-readable recording medium of claim 18, wherein the gamma parameters and brightness offset values are mapped in the first look-up table for representative orientation angles, and
the second set of instructions further interpolate the gamma parameter and a brightness offset value from a neighboring representative orientation angle when the detected orientation angle does not correspond to one of the representative orientation angles stored in the first look-up table.

21. The computer-readable recording medium of claim 16, further comprising:
a fourth set of instructions for controlling the image correction unit for color-correcting the input image and brightness-correcting the color-corrected image according to the detected orientation angle.

22. The computer-readable recording medium of claim 21, wherein the fourth set of instructions comprise:
a set of instructions for obtaining corrected color component values corresponding to color component values of pixels constituting the input image from a second look-up table in which the color component values and corrected color component values respectively corresponding to the color component values are previously mapped, and changing the color component values of the pixels to the obtained corrected color component values.

23. The computer-readable recording medium of claim 22, further comprising:
a set of instructions for interpolating corrected color component values from neighboring color component values when the color component values of the pixels constituting the input image do not exist in the second look-up table, and changing the color component values of the pixels to the interpolated corrected color component values.

24. A viewing angle adaptive brightness-correction method in which brightness of an image is adaptively corrected according to a viewing angle and the brightness-corrected image is displayed by an image display unit whose orientation angle is controllable, the method comprising:
brightness-correcting an input image according to a detected orientation angle of an image display unit; and
displaying the brightness-corrected image on the image display unit.

25. The method of claim 24, further comprising detecting the orientation angle of the image display unit.

26. The method of claim 24, wherein the step of brightness-correcting an input image comprises controlling at least one of a gamma parameter and brightness offset according to the detected orientation angle.

27. The method of claim 26, wherein the step of brightness-correcting an input image comprises obtaining at least one of a gamma parameter and brightness offset corresponding to the detected orientation angle from a first look-up table comprising at least one of angles, gamma parameters and brightness offset values.

28. The method of claim 27, wherein:
the gamma parameters and brightness offset values are mapped in the first look-up table for representative orientation angles, and
the step of brightness-correcting an input image further comprises interpolating the gamma parameter and a brightness offset value from a neighboring representative orientation angle when the detected orientation angle does not correspond to one of the representative orientation angles stored in the first look-up table.

29. The method of claim 24, wherein the step of brightness-correcting an input image comprises:
color-correcting the input image; and
brightness-correcting the color-corrected image according to the detected orientation angle.

30. The method of claim 29, wherein the step of color-correcting the input image comprises:
obtaining corrected color component values corresponding to color component values of pixels constituting the input image from a second look-up table; and
changing the color component values of the pixels to the obtained corrected color component values.

31. The method of claim 30, wherein the corrected color component values for respective representative color component values are mapped in the second look-up table, and the step of color-correcting the input image further comprises:
interpolating corrected color component values from neighboring color component values when the color component values of the pixels constituting the input image are not present in the second look-up table; and
changing the color component values of the pixels to the interpolated corrected color component values.

32. An image forming apparatus, comprising:
an angle detector for detecting an orientation angle of an image display unit; and
an image correction unit for brightness-correcting an input image according to the detected orientation angle.

33. The image forming apparatus of claim 32, further comprising an image display unit, wherein the image display unit is configured to display the brightness-corrected image.

34. The image forming apparatus of claim 32, wherein the image correction unit is configured to obtain at least one of a gamma parameter and brightness offset corresponding to the detected orientation angle from a first look-up table comprising at least one of angles, gamma parameters and brightness offset values.

35. The image forming apparatus of claim 34, wherein:
the gamma parameters and brightness offset values are mapped in the first look-up table for representative orientation angles, and
the image correction unit is configured to interpolate the gamma parameter and a brightness offset value from a neighboring representative orientation angle when the detected orientation angle does not correspond to one of the representative orientation angles stored in the first look-up table.

36. The image forming apparatus of claim 32, wherein the image correction unit comprises:
a color correction unit for color-correcting the input image; and
a brightness correction unit for brightness-correcting the color-corrected image according to the detected orientation angle.

37. The image forming apparatus of claim 36, wherein:
the color correction unit is configured to obtain corrected color component values corresponding to color component values of pixels constituting the input image from a second look-up table, and change the color component values of the pixels to the obtained corrected color component values.

38. The image forming apparatus of claim 37, wherein:
corrected color component values for respective representative color component values are mapped in the second look-up table, and
the color correction unit is configured to interpolate corrected color component values from neighboring color component values when the color component values of the pixels constituting the input image are not present in the second look-up table, and change the color component values of the pixels to the interpolated corrected color component values.
